(19) United States
(12) Patent Application Publication
(10) Pub. No.: US 2024/0320749 A1
(43) Pub. Date: Sep. 26, 2024

(54) INSURANCE LOSS RATIO FORECASTING FRAMEWORK

(71) Applicant: THE DUN BRADSTREET CORPORATION, JACKSONVILLE, FL (US)

(72) Inventors: Nilay Chandra, Jacksonville, FL (US); Paul Chin, Whippany, NJ (US); Shankarram Subramanian, Chennai (IN); Aravind Rajaelangovan, Madipakkam (IN)

(73) Assignee: THE DUN BRADSTREET CORPORATION, JACKSONVILLE, FL (US)

(21) Appl. No.: 18/609,626

(22) Filed: Mar. 19, 2024

Related U.S. Application Data
(60) Provisional application No. 63/453,363, filed on Mar. 20, 2023.
(60) Provisional application No. 63/622,869, filed on Jan. 19, 2024.

(51) Int. Cl. G06Q 40/08; G06Q 10/04

(52) U.S. Cl. CPC G06Q 40/08; G06Q 10/04

(57) ABSTRACT

A system and method for insurance loss ratio forecasting, which utilizes faster feature reduction by blending traditional statistical method and feature importance, and applying a Boruta algorithm for further feature reduction. Final feature selection is achieved by creating a balance between Light GBM model feature importance and coverage rate. These processes are all completely automated. Faster hyperparameter tuning is achieved by applying a randomized search algorithm. In the out-of-time sample dataset and production sample dataset for an insurance loss ratio forecast, faster segmentation is conducted by applying unsupervised ML, using cosine similarity. The system is a significant technical improvement, which requires uniquely critical computer implementation and ensures that the models are stable for users, across different samples of data, without extensive fine tuning and no manual searches. In addition, the system framework is easy for non-native users to use, enabling almost anyone to build ML models.

### CROSS REFERENCE TO RELATED APPLICATION

The present application claims the priority from and benefit under 35 U.S.C. § 119 of U.S. Provisional Patent Application No. 63/453,383, filed on Mar. 20, 2023, and U.S. Provisional Patent Application No. 63/622,869, filed on Jan. 19, 2024, the contents of which are incorporated herein by reference in their entireties.

### BACKGROUND

### 1. Field of the Disclosure

The present disclosure relates to a new technique to forecast Insurance Loss Ratio, which is defined as dollar claims over dollar premium. More particularly, it relates to a computer automated method and system for accomplishing the same.

### 2. Description of the Related Art

Conventional techniques for machine learning models utilizing segmentation and missing value imputations such as mean, median values at overall level (entire data) are deeply affected by the data, and therefore, this affects the variability of the analysis. Using these traditional approaches in insurance loss ratio forecasting will result in very low capture rates, especially in the extreme loss ratio bins, thus adversely affecting the model performance.

There exist systems for machine learning models, which are known to have instability of performance over time, due to difference in the measurement of performance and in workflow design. However, to ensure a stable model, the traditional approach of feature selection often leverages techniques such as variable binning along with correlation and exploratory data analysis. Following this traditional approach in insurance loss ratio forecasting will also result in very low capture rates, especially in the extreme loss ratio bins, and thus, also adversely affecting the model performance.

There is a need for a machine learning model utilizing an automated function which ensures superior variable selection, and thereby better performance, as well as no issues of over-fitting of data.

### SUMMARY

The present disclosure utilizes an automated function which ensures superior variable selection, and thereby, better performance as well as no over-fitting issue. As such, the framework is also easy for non-native users to use, enabling almost anyone to build machine learning (ML) models.

Some of the technical problems being solved by this disclosure are related to feature selection and hyperparameter tuning, thereby solving the over-fitting issue caused by ML models. Thus, the resulting solution is risk-based segmentation using unsupervised ML. The process performed, and the result obtained by the invention are almost impossible for a human being to obtain.

The present disclosure relates to utilizing feature reduction, parameter selection, and segmentation in the out-of-time (OOT) sample and modeling, which is fully based on machine learning (ML) techniques and is completely automated. Further, it has been observed that machine learning models yield superior predictions in comparison to traditional generalized linear models (GLM), therefore, ensuring that customers are able to best utilize this sophisticated methodology and leverage large object data.

In general, an embodiment of the disclosure is directed to a system and method for feature selection, parameter searching, risk-based segmentation and missing value imputation, Explainability, and reporting, which are enhanced, by utilizing a machine learning model, developed with an automated function which ensures superior variable selection, and thereby better performance, as well as no over-fitting issue. Further, the model building process leverages an iterative process, during which users are ensured that they can choose appropriate risk drivers and thereby corresponding hyperparameters based on the maximum R-square, capture rates in the loss ratio bins between development, and hold-out samples, resulting in a stable model over time.

The present disclosure provides a system and method for a unique technique for forecasting Insurance Loss Ratio, by utilizing a framework wherein data is growing exponentially. However, it is important to select features to reduce the complexity of the model and computational cost, while maintaining the performance of the model. The insurance loss ratio forecasting framework disclosed herein uses different techniques, by blending traditional statistical approaches and ML algorithms. Traditional statistical methods using a combination of correlation and cluster analysis and blended with feature importance based on a Random Forest algorithm can be included, as well as, further leveraging a Boruta algorithm (a ML based technique) to reduce the number of variables. For final variable selection, to select the best predictors for the model, a balance of feature importance, based on a Light Gradient Boosting Machine (GBM) model and coverage is used. There is no manual intervention in this process; it is fully driven by machine automated, statistical techniques.

The insurance loss ratio forecasting framework disclosed herein is a system and method which allows randomized parametric searching to facilitate selection of the best model. This is achieved by running iterations of a randomized search, and by selecting random combinations of parameters and passing it to model training. The best set of hyperparameters are selected based on the set that maximizes R-square.

The present disclosure also provides a system and method for utilizing a unique technique for forecasting of Insurance Loss Ratio, by utilizing a framework for treatment of missing values in data. The imputation (a method for retaining the majority of the dataset's data and information by substituting missing data with a different value) leverages the power of an unsupervised ML technique (cosine similarity) which helps to segment the OOT sample to identify the appropriate risk segment (closest loss ratio bin) and then uses a median value of that assigned loss ratio bin to fill in the missing values. Rather than using traditional methods utilizing simple mean or median of overall data, this technique is designed for low latency (using matrix multiplications—NumPy operations (Python)) and increases the final prediction scores.

Further, as disclosed herein, Explainabilty of machine learning models is achieved in insurance loss ratio forecasting models, by utilizing a Light GBM model, wherein the variable impact in both directions and the power of the variables is measured using Shapley values (SHapley Additive explanations, hereinafter “Shapley values”). The system and method for a unique technique for forecasting of insurance loss ratio, expands each of processes such as EDA, Correlation, Cluster Analysis, Feature Importance, Feature reduction, Model performance statistics, Capture rates, Shapley value and a final list of selected variables and their corresponding description with coverage rates, in automated reports. These detailed auto-generated HTML reports, provided by the framework, significantly assist in making business decisions.

An embodiment of the disclosure is directed to a system and method for utilizing feature reduction, parameter selection, and segmentation in the out-of-time (OOT) sample and modeling, which is based on machine learning (ML) techniques and is completely automated. Furthermore, these machine learning models yield superior predictions, to ensure that customers can best utilize this sophisticated methodology and leverage the large object data. As such, the framework is easy for non-native users to use, enabling almost anyone to build ML models.

As disclosed herein, a system for insurance loss ratio forecasting, utilizing a framework consisting of risk-based segmentation using unsupervised machine learning, comprises: a computer processor; a memory for storing a set of instructions for the computer processor; a plurality of databases, accessible by said processor, including at least a database of variables, a database of feature importance, and a database of hyperparameters, wherein the set of instructions in the memory cause the computer processor to perform steps of: using a combination of correlation, cluster analysis and feature importance for a feature reduction of variables in a first selection, wherein the feature reduction of variables is reduced in a second selection using a Boruta algorithm; and capturing features involving a combination of coverage rate and feature importance from a Light GBM model; tuning of selected features from the second selection, utilizing a randomized search algorithm, which utilizes different combinations of hyperparameters, and selecting a best set of hyperparameters that provide a maximum R-square in a model development; wherein risk-based segmentation is used in the model development, and in order to capture the risk-based segmentation in a OOT sample dataset and a production sample dataset for an insurance loss ratio forecast, and unsupervised machine learning (ML) utilizing cosine similarity technique, is leveraged to capture the risk-based segmentation.

The disclosure is also directed to a method for insurance loss ratio forecasting, utilizing a framework consisting of risk-based segmentation using unsupervised machine learning, comprising: using a combination of correlation, cluster analysis and feature importance for a feature reduction of variables in a first selection, wherein the feature reduction of variables is reduced in a second selection using a Boruta algorithm; and capturing features involving a combination of coverage rate and feature importance from a Light GBM model; tuning of selected features from the second selection, utilizing a randomized search algorithm, which utilizes different combinations of hyperparameters, and selecting a best set of hyperparameters that provide a maximum R-square in a model development; wherein risk-based segmentation is used in the model development, and in order to capture the risk-based segmentation in a OOT sample dataset and a production sample dataset for an insurance loss ratio forecast, and unsupervised machine learning (ML) utilizing cosine similarity technique, is leveraged to capture the risk-based segmentation.

The disclosure is further directed to a system for insurance loss ration forecasting, utilizing a framework consisting of risk-based segmentation using unsupervised machine learning, comprising: a computer processor; a memory for storing a set of instructions for the computer processor; a plurality of databases, accessible by said processor, including at least a database of variables, a database of feature importance, and a database of hyperparameters, wherein the set of instructions in the memory cause the computer processor to perform steps of: using a combination of correlation, cluster analysis, feature importance, and missing value imputation for a feature reduction of variables in a first selection, wherein the feature reduction of variables is reduced in a second selection using a Boruta algorithm; and capturing features involving a combination of coverage rate and feature importance from a Light GBM model; tuning of selected features from the second selection, utilizing a randomized search algorithm, which utilizes different combinations of hyperparameters, and selecting a best set of hyperparameters that provide a maximum R-square in a model development; wherein risk-based segmentation is used in the model development, and in order to capture the risk-based segmentation in a OOT sample dataset and a production sample dataset for an insurance loss ratio forecast, and unsupervised machine learning (ML) utilizing cosine similarity technique, is leveraged to capture the risk-based segmentation.

The system, wherein the missing value imputation comprises an unsupervised machine learning (ML) model derived through cosine similarity to assign risk-based segmentation for a full dataset and to impute missing values in the full dataset with median values corresponding to specific risk segments that are used in a base data repository.

The system, wherein the missing value imputation comprises an unsupervised machine learning (ML) model derived through cosine similarity to at least: create a base dataset that is used for mapping; create loss ratio bins and impute missing values based on median values corresponding to those bins; randomly draw a population and save it as base data for cosine similarity; and assign risk-based segmentation for a full dataset and impute missing values in the full dataset with median values corresponding to specific risk segments that are used in a base data repository.

The disclosure is yet further directed to a method for insurance loss ratio forecasting, utilizing a framework consisting of risk-based segmentation using unsupervised machine learning, comprising: using a combination of correlation, cluster analysis, feature importance, and missing value imputation for a feature reduction of variables in a first selection, wherein the feature reduction of variables is reduced in a second selection using a Boruta algorithm; and capturing features involving a combination of coverage rate and feature importance from a Light GBM model; tuning of selected features from the second selection, utilizing a randomized search algorithm, which utilizes different combinations of hyperparameters, and selecting a best set of hyperparameters that provide a maximum R-square in a model development; wherein risk-based segmentation is used in the model development, and in order to capture the risk-based segmentation in a OOT sample dataset and a production sample dataset for an insurance loss ratio forecast, and unsupervised machine learning (ML) utilizing cosine similarity technique, is leveraged to capture the risk-based segmentation.

The method, wherein the missing value imputation comprises an unsupervised machine learning (ML) model derived through cosine similarity to assign risk-based segmentation for a full dataset and to impute missing values in the full dataset with median values corresponding to specific risk segments that are used in a base data repository.

The method, wherein the missing value imputation comprises an unsupervised machine learning (ML) model derived through cosine similarity to at least: create a base dataset that is used for mapping; create loss ratio bins and impute missing values based on median values corresponding to those bins; randomly draw a population and save it as base data for cosine similarity; and assign risk-based segmentation for a full dataset and impute missing values in the full dataset with median values corresponding to specific risk segments that are used in a base data repository.

### BRIEF DESCRIPTION OF THE DRAWINGS

FIG. 1 is a flow chart of the system according to the present disclosure for insurance loss ratio forecasting, utilizing a framework consisting of risk-based segmentation using unsupervised machine learning.

FIG. 2 is a flow chart of the system for insurance loss ratio forecasting, utilizing a framework consisting of risk-based segmentation using unsupervised machine learning, according to an alternative embodiment.

FIG. 3 is a logic diagram and flow chart of the system incorporating the framework of FIG. 1 or FIG. 2, according to the present disclosure for insurance loss ratio forecasting of a user for an insurance company.

FIG. 4 is a system architecture depicting a computer system and network, for employment of the present disclosure.

A component or a feature that is common to more than one drawing is indicated with the same reference number in each of the drawings.

### DETAILED DESCRIPTION OF THE PREFERRED EMBODIMENTS

In general, as used herein, features, predictors, hyperparameters and artifacts, are all different stages of variables within the execution of the framework of an iterative process. The term changes as the processes of Steps 1-20 are conducted, going from the largest collection of variables (features) to the smallest collection of variables (artifacts).

The present disclosure utilizes a framework comprising machine learning models, which yield superior predictions in comparison to traditional generalized linear models, to ultimately ensure that customers can best utilize this sophisticated methodology and leverage the large object data.

As the data is growing exponentially, it is important to select features to reduce complexity of the model and computational cost, while maintaining the unique performance of the model. The insurance loss ratio modeling framework disclosed herein, uses different techniques, blending traditional statistical approaches and feature importance from a ML model and a Boruta algorithm to select the best predictors for the model.

The present disclosure of insurance loss ratio modeling framework uses a randomized parametric search to facilitate selection of the best model. Hyperparameters are selected based on the randomized search algorithm, which maximizes R-square.

Traditional missing value imputations such as mean, median values at overall level (entire data) are deeply affected by the data, and therefore, affect the variability of a result. Using this traditional approach in insurance loss ratio forecasting generally will result in extremely low capture rates, especially in the extreme loss ratio bins, and thus, adversely affecting the performance of the model being used. The present imputation technique leverages the power of an unsupervised ML technique (cosine similarity), which helps to segment the OOT sample to identify the appropriate risk segment (closest loss ratio bin), and then uses the median value of that assigned loss ratio bin to fill in the missing values. This ensures low latency and high prediction performance.

The present disclosure of an insurance loss ratio forecasting framework, is a machine learning approach that has been developed to build high quality models faster with less effort. This machine learning modeling framework has multiple approaches to explain or account for the impact of the variables on the computed loss ratio, wherein Shapley values are used to determine the impact as well as the direction of the impact of the variables (positive or negative).

The present disclosure generates automated reports. It also explains each process, such as EDA, correlation, cluster analysis, feature importance, feature reduction, model performance statistics, capture rates, Shapley value and a final list of selected variables and their corresponding description, with coverage rates. These detailed auto-generated HTML reports, provided by the framework, significantly assist in making business decisions.

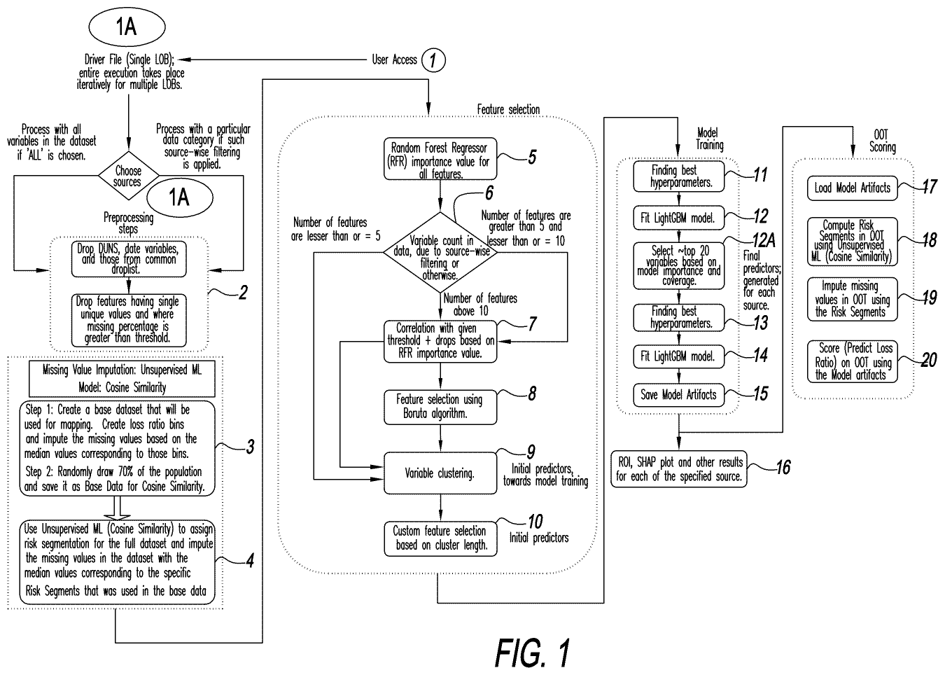

In FIG. 1, a flow chart of the system for insurance loss ratio forecasting, utilizing a framework consisting of risk-based segmentation using unsupervised machine learning is shown, according to the present disclosure. FIG. 1, commences operation with a driver file for a single line of business (LOB). The entire execution takes place iteratively for multiple LOBs, sources of variables in a dataset, pre-processing steps, feature selection, initial predictors towards model training and initial predictors, model training of initial predictors, model training for final predictors, final predictors generated for each source of variables in the dataset, and OOT scoring of loaded model artifacts for predicting loss ratio, as the present system and method states throughout each step in the flow of the system and method. The flow of the system and method starts at Step 1, where the User accesses the system and logs into a registered account. At Step 1A, through use of a driver file, either by utilizing a single LOB or multiple LOBs, a choice is made of selecting either all variables in the dataset if “ALL” is chosen, or a particular data category if such source-wise filtering is applied.

When the sources are chosen, the system proceeds to the beginning of pre-processing at Step 2, including but not limited to, dropping of DUNS number, date variables, and those from a common drop list, including the dropping of features having single unique values and where missing percentage is greater than a threshold. Step 3 includes but is not limited to, missing value imputation by utilizing an unsupervised machine learning (ML) model derived through cosine similarity to, (1): create a base dataset that may be used for mapping. Further, the system proceeds to create loss ratio bins and impute the missing values based on the median values corresponding to those bins. Then, the system proceeds to, (2): randomly draw 70% of the population and save it as base data for cosine similarity. Then the system proceeds to Step 4, which includes, but is not limited to, use of unsupervised ML (cosine similarity) to assign risk segmentation for the full dataset and impute the missing values in the dataset with the median values corresponding to the specific risk segments that were used in the base data.

When the pre-processing steps are completed, the system proceeds to feature selection beginning at Step 5, where a Random Forest Regressor (RFR) determines the importance value for all features of variables. Then the system proceeds to Step 6, variable count in data, due to source-wise filtering. If the number of features is less than or equal to 5, the system proceeds to Step 9, variable clustering. If, at Step 6, the number of features is greater than 5 and less than or equal to 10, the system proceeds to Step 7, where correlation with a given threshold occurs and features are dropped based on RFR importance value. Then the system skips Step 8 and proceeds to Step 9, variable clustering. However, if at Step 6, the number of features is more than 10, the system proceeds to Step 7, and then to Step 8 wherein features of greater importance are selected using a Boruta algorithm. After Step 7 is executed or skipped, the system proceeds to Step 8, wherein features of greater importance are selected using the Boruta algorithm. Then the system proceeds to Step 9, where variable clustering is performed, either from a pathway of previous Step 6, previous step 7, or from previous Step 8. From any of the foregoing pathways of processing, the variable clustering of Step 9 further selects features of more importance to the system model, to be used as initial predictors for model training. Then the system proceeds to Step 10, wherein custom feature selection of more importance, based on cluster length, is performed to determine the initial predictors for model training.

After the initial predictors are organized, customized, and processed towards model training, the system proceeds to the beginning of model training, at Step 11. Model training includes finding the best hyperparameters from the initial predictors by utilizing a randomized search algorithm, which utilizes different combinations of hyperparameters and selects the best set of hyperparameters that provide a maximum R-square. Then the system proceeds to Step 12, which includes fitting a Light GBM model with the best hyperparameters selected from the previous iteration having a specified number of observations so that the model does not become too specific. Capturing final features involves a combination of coverage rate and feature importance. Final predictors are generated for each source of dataset. First, at Step 12A, selection of approximately the top 20 variables based on model importance and coverage is performed. Then, again at Step 13, further finding of the best hyperparameters from the initial predictors by utilizing a randomized search algorithm, which utilizes different combinations of hyperparameters and selects the best set of hyperparameters that provide a maximum R-square, is performed a second time for even more refined and accurate hyperparameters and/or final predictors for each source of dataset. Then, again at Step 14, further fitting of a Light GBM model occurs, wherein capturing superior final features comprises determining a combination of coverage rate and feature importance. Final predictors are generated for each source of a dataset. If processing of the system for model development is completed, the system proceeds to saving the model artifacts, at Step 15, as this is the actual model to be used in the OOT scoring. If the model artifacts are saved, then the system proceeds to Step 16, model development, wherein ROI (Return on Investment), capture rates, model performance statistics, SHAP plot (Shapley values) and other results for each of the specified sources of datasets are executed and determined, and the variable impact in both directions of the processing of the model, regarding the computed loss ratio and the strength of the variables of the saved model artifacts is measured using Shapley values. The saved model artifacts are loaded into the system to process the OOT scoring, at Step 17, the first step in OOT scoring.

The system then proceeds to Step 18, wherein risk segments in OOT are computed using unsupervised ML (cosine similarity). Then, the system proceeds to Step 19, during which imputing of missing values in OOT occurs, using the computed risk segments. Finally, the system proceeds to Step 20, wherein the score and/or predicted loss ratio in OOT processing is determined using the model artifacts from the model development. Previously, the extensive processing of the kind done in Steps 1-16 took many months to complete, wherein in the present disclosure, generally it is completed in a time less than or equal to one hour. Computing a result score and/or predicted loss ratio, used to take approximately three months, wherein in the present disclosure it is completed in less than or equal to two minutes of time, to process a score and/or predicted loss ratio in OOT processing using the superior model artifacts developed from the loss ratio bin. Each insurance customer will use only one score, which can be individualized for that customer in accordance with their superior features of importance.

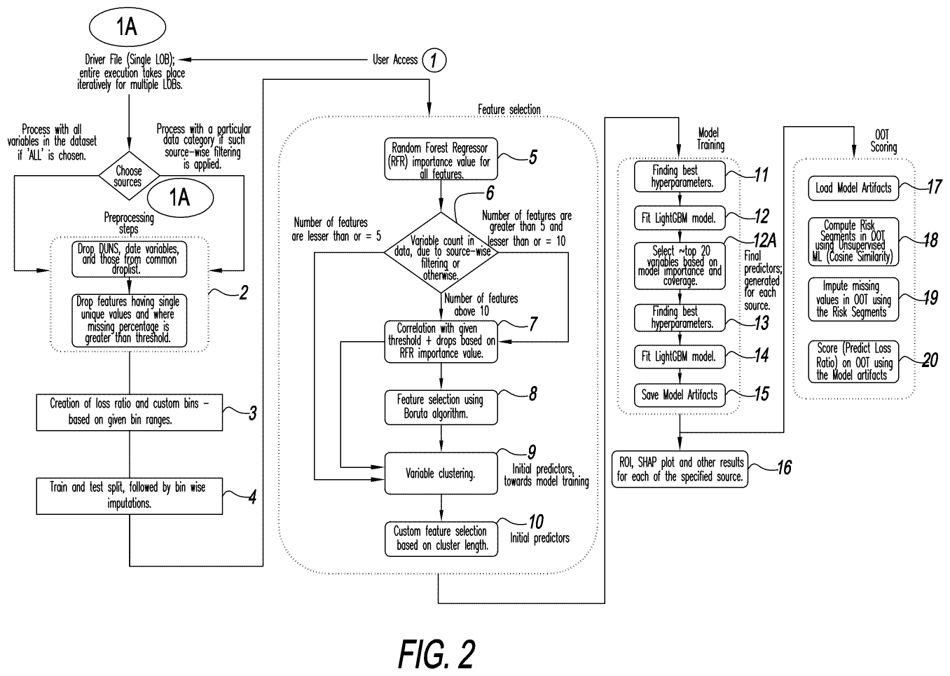

In FIG. 2, a flow chart of the system for insurance loss ratio forecasting, utilizing a framework consisting of risk-based segmentation using unsupervised machine learning is shown, according to an alternative embodiment. FIG. 2, commences operation with a driver file for a single line of business (LOB). The entire execution takes place iteratively for multiple LOBs, sources of variables in a dataset, pre-processing steps, feature selection, initial predictors towards model training and initial predictors, model training of initial predictors, model training for final predictors, final predictors generated for each source of variables in the dataset, and OOT scoring of loaded model artifacts for predicting loss ratio, as the present system and method states throughout each step in the flow of the system and method. The flow of the system and method starts at Step 1, where the User accesses the system and logs into a registered account. At Step 1A, through use of a driver file, either by utilizing a single LOB or multiple LOBs, a choice is made of selecting either all variables in the dataset if “ALL” is chosen, or a particular data category if such source-wise filtering is applied.

When the sources are chosen, the system proceeds to the beginning of pre-processing at Step 2, including but not limited to, dropping of DUNS number, date variables, and those from a common drop list, including the dropping of features having single unique values and where missing percentage is greater than a threshold. Step 3 includes but is not limited to, creating loss ratio and custom bins-based on given bin ranges. Then the system proceeds to Step 4, which includes, but is not limited to, a train and test split of the data, followed by bin wise imputations, wherein a majority of data is retained from the dataset and information, by substituting missing data with a different value driven by a ML algorithm, rather than manual intervention.

When the pre-processing steps are completed, the system proceeds to feature selection beginning at Step 5, where a Random Forest Regressor (RFR) determines the importance value for all features of variables. Then the system proceeds to Step 6, variable count in data, due to source-wise filtering. If the number of features is less than or equal to 5, the system proceeds to Step 9, variable clustering. If, at Step 6, the number of features is greater than 5 and less than or equal to 10, the system proceeds to Step 7, where correlation with a given threshold occurs and features are dropped based on RFR importance value. Then the system skips Step 8 and proceeds to Step 9, variable clustering. However, if at Step 6, the number of features is more than 10, the system proceeds to Step 7, and then to Step 8 wherein features of greater importance are selected using a Boruta algorithm. After Step 7 is executed or skipped, the system proceeds to Step 8, wherein features of greater importance are selected using the Boruta algorithm. Then the system proceeds to Step 9, where variable clustering is performed, either from a pathway of previous Step 6, previous step 7, or from previous Step 8. From any of the foregoing pathways of processing, the variable clustering of Step 9 further selects features of more importance to the system model, to be used as initial predictors for model training. Then the system proceeds to Step 10, wherein custom feature selection of more importance, based on cluster length, is performed to determine the initial predictors for model training.

After the initial predictors are organized, customized, and processed towards model training, the system proceeds to the beginning of model training, at Step 11. Model training includes finding the best hyperparameters from the initial predictors by utilizing a randomized search algorithm, which utilizes different combinations of hyperparameters and selects the best set of hyperparameters that provide a maximum R-square. Then the system proceeds to Step 12, which includes fitting a Light GBM model with the best hyperparameters selected from the previous iteration having a specified number of observations so that the model does not become too specific. Capturing final features involves a combination of coverage rate and feature importance. Final predictors are generated for each source of dataset. First, at Step 12A, selection of approximately the top 20 variables based on model importance and coverage is performed. Then, again at Step 13, further finding of the best hyperparameters from the initial predictors by utilizing a randomized search algorithm, which utilizes different combinations of hyperparameters and selects the best set of hyperparameters that provide a maximum R-square, is performed a second time for even more refined and accurate hyperparameters and/or final predictors for each source of dataset. Then, again at Step 14, further fitting of a Light GBM model occurs, wherein capturing superior final features comprises determining a combination of coverage rate and feature importance. Final predictors are generated for each source of a dataset. If processing of the system for model development is completed, the system proceeds to saving the model artifacts, at Step 15, as this is the actual model to be used in the OOT scoring. If the model artifacts are saved, then the system proceeds to Step 16, model development, wherein ROI (Return on Investment), capture rates, model performance statistics, SHAP plot (Shapley values) and other results for each of the specified sources of datasets are executed and determined, and the variable impact in both directions of the processing of the model, regarding the computed loss ratio and the strength of the variables of the saved model artifacts is measured using Shapley values. The saved model artifacts are loaded into the system to process the OOT scoring, at Step 17, the first step in OOT scoring.

The system then proceeds to Step 18, wherein risk segments in OOT are computed using unsupervised ML (cosine similarity). Then, the system proceeds to Step 19, imputing of missing values in OOT occurs, using the computed risk segments. Finally, the system proceeds to Step 20, wherein the score and/or predicted loss ratio in OOT processing is determined using the model artifacts from the model development. Previously, the extensive processing of the kind done in Steps 1-16 took many months to complete, wherein in the present disclosure, generally it is completed in a time less than or equal to one hour. Computing a result score and/or predicted loss ratio, used to take approximately three months, wherein in the present disclosure it is completed in less than or equal to two minutes of time, to process a score and/or predicted loss ratio in OOT processing using the superior model artifacts developed from the loss ratio bin. Each insurance customer will use only one score, which can be individualized for that customer in accordance with their superior features of importance.

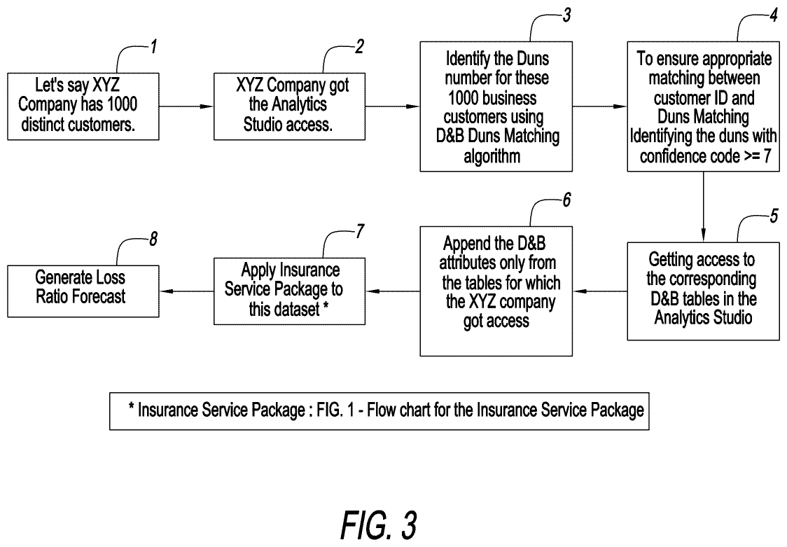

In FIG. 3, a flow chart of the system incorporating the framework of FIG. 1 or FIG. 2, for insurance loss ratio forecasting of a user, which may be an insurance company, is shown, according to the present disclosure. At Step 1, any company, or at least, for example, XYZ Company has 1000 distinct customers. Then, at Step 2, any company or at least XYZ Company. acquires access to the Dun & Bradstreet (D & B) Analytics Studio. At Step 3 the DUNS number for these 1000 business customers is identified using the Dun & Bradstreet (Duns) matching algorithm. Then, at Step 4, to ensure appropriate matching between customer ID and DUNS, matching to identify the DUNS with a confidence code>=7 is performed. At Step 5, access to the corresponding D&B tables in the Analytics Studio is utilized. Then, at Step 6, the D&B attributes only from the tables for which a company, or at least. for example, the XYZ company, were granted access are appended. Then, at Step 7, the Insurance Service Package, as shown in FIG. 1 or FIG. 2, is applied to this dataset. Then, ultimately at Step 8, a uniquely bespoke insurance loss ratio forecast for a specific user and/or customer, is generated.

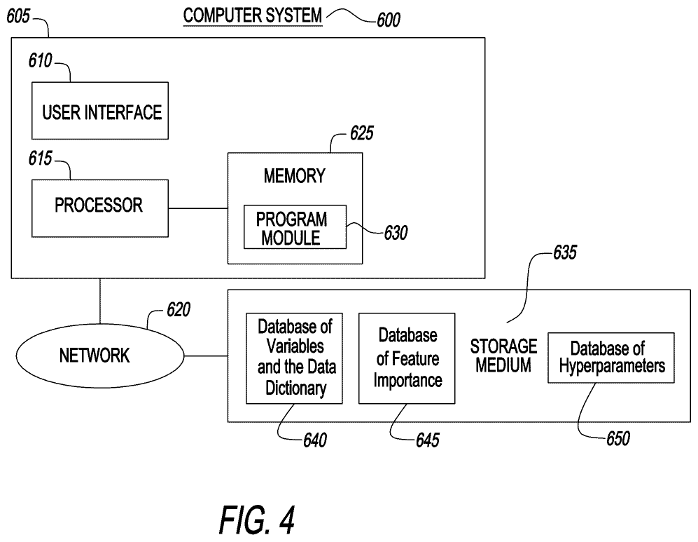

In FIG. 4, a block diagram of a computer system 600 is shown, for implementation of a system in accordance with the present disclosure. Computer system 600 includes a computer 605 coupled to a network 620, e.g., the Internet.

Computer 605 includes a user interface 610, a processor 615, and a memory 625. Computer 605 may be implemented on a general-purpose microcomputer. Although computer 605 is represented herein as a standalone device, it is not limited to such, but instead can be coupled to other devices (not shown) via network 620.

Processor 615 is configured of logic circuitry that responds to and executes instructions in accordance with this disclosure. Processor 615 may be configured and programmed to control the Insurance Loss Ratio Forecasting framework, a system and method for utilizing a framework consisting of risk-based segmentation using unsupervised machine learning. Processor 615 controls the systems and methods, utilizing the Insurance Loss Ratio Forecasting framework. Further, processor 615 may be configured and programmed to control the Insurance Loss Ratio Forecasting framework, wherein the system and method framework is consistent with the needs of the insurance industry, and easy for non-native users to use, enabling almost anyone to build ML models.

Memory 625 stores data and instructions for controlling the operation of processor 615. Memory 625 may be implemented in a random-access memory (RAM), a hard drive, a read-only memory (ROM), a programmable read-only memory (PROM), or a combination thereof. One of the components of memory 625 is a program module 630.

Program module 630 contains instructions for controlling processor 615 to execute the methods described herein. For example, as a result of execution of program module 630, processor 615 utilizes a combination of correlation, cluster analysis and feature importance for a feature reduction of variables in a first selection, wherein the feature reduction of variables is reduced in a second selection using Boruta algorithm; and capturing features involving a combination of coverage rate and feature importance from a Light GBM model; tuning of selected features from the second selection, utilizing a randomized search algorithm, which utilizes different combinations of hyperparameters, and selecting a best set of hyperparameters that provide a maximum R-square in a model development; wherein risk-based segmentation is used in the model development, and in order to capture the risk-based segmentation in a OOT sample dataset and a production sample dataset for an insurance loss ratio forecast, unsupervised machine learning (ML) utilizing cosine similarity technique, is leveraged to capture the risk-based segmentation.

The term “module” is used herein to denote a functional operation that may be embodied either as a stand-alone component or as an integrated configuration of a plurality of sub-ordinate components. Thus, program module 630 may be implemented as a single module or as a plurality of modules that operate in cooperation with one another. Moreover, although program module 630 is described herein as being installed in memory 625, and therefore being implemented in software, it could be implemented in any hardware (e.g., electronic circuitry), firmware, software, or a combination thereof.

User interface 610 includes an input device, such as a keyboard, biometrics or speech recognition subsystem, for enabling a user to communicate information and command selections to processor 615. User interface 610 also includes an output device such as a display or a printer. A cursor control such as a mouse, track-ball, or joy stick, allows the user to manipulate a cursor on the display for communicating additional information and command selections to processor 615.

Processor 615 outputs, to user interface 610, a result of an execution of the methods described herein. Alternatively, processor 615 could direct the output to a remote device (not shown) via network 620.

While program module 630 is indicated as already loaded into memory 625, it may be configured on a storage medium 635 for subsequent loading into memory 625. Storage medium 635 can be any conventional storage medium that stores program module 630 thereon in tangible form. Examples of storage medium 635 include a floppy disk, a compact disk, a magnetic tape, a read only memory, an optical storage media, a universal serial bus (USB) flash drive, a secure digital (SD) card, a digital versatile disc, or a zip drive. Alternatively, storage medium 635 can be a random-access memory, or other type of electronic storage, located on a remote storage system and coupled to computer 605 via network 620. Storage medium 635 can include a plurality of databases, accessible by processor 615, coupled to computer 605 via network 620, including at least a database of variables and its corresponding data dictionary 640, a database of feature importance 645, and a database of hyperparameters 650.

The significant technical implementation of the present disclosure comprises feature reduction using a combination of correlation, cluster analysis and feature importance. The next layer of feature reduction is using Boruta algorithm. Finally capturing features involves a combination of coverage rate and feature importance from the Light GBM model. Hyperparameter tuning involves application of a randomized search algorithm, which utilizes different combinations of hyperparameters and selects the best set of hyperparameters that provide a maximum R-square. Risk-based segmentation is used in the model development, so in order to capture the risk-based segmentation in a OOT sample dataset and a production sample dataset for an insurance loss ratio forecast, unsupervised ML (cosine similarity) technique is leveraged to capture the risk segmentation.

The enhanced performance results of the present disclosure comprise faster feature reduction by blending traditional statistical method and feature importance, and finally applying Boruta algorithm for further feature reduction. Final feature selection is achieved by creating a balance between Light GBM model feature importance and coverage rate. These processes are all automated by using a computer. Faster hyperparameter tuning is achieved by applying randomized search algorithm. However, in the out-of-time sample and production sample datasets, for an insurance loss ratio forecast, faster segmentation is conducted by applying unsupervised ML (cosine similarity).

The present disclosure is a significant technical improvement, which requires computer implementation and ensures that the models are stable across different samples of data, as opposed to standard methodology, which does not result in standard/stable models, and requires extensive fine tuning and manual searches.

### Specific Use Case Examples

### Insurance Loss Ratio Service Package

Objective: A commercially viable product.

Critical component in the package: Time taken by each statistical step is uniquely critical.

Major Hurdles to make the time efficient:

Mathematical computational challenges with big data.

### Solution

Technical Infrastructure: The computation is being conducted in AWS cloud space within a Databricks platform. In Databricks, a dedicated cluster is allocated for modeling and analytics, which ensures appropriate cluster speed and availability. This in turn, ensures the faster run time of the insurance modeling codes.

### Improving the Mathematical Computation Speed:

Initial Data Pre-processing and cleaning: Initial data pre-processing cleans up the data and filters of the variables that are not used in modeling, and the variables that are taking single values, and also the variables that have more than 97% missing values.

Feature Reduction: This is an important step as the computation speed depends on this process. An organization such as, for example, Dun & Bradstreet has a vast number of risk attributes; the question becomes, which ones to use as candidate variables. Model candidate variables needs to be selected based on statistical technique. Prior to developing the methods disclosed herein, the feature reduction process took several weeks to complete and was not efficient. Earlier yet, each feature reduction step was done in isolated fashion. In the present disclosure, the way each of these isolated feature reduction steps are arranged, significantly speeds up the process, and is more accurate and efficient. The first step to reduce features is based on a correlation coefficient. If two variables are correlated, then the variables that get dropped are the variables that have lower feature importance, which is based on the random forest model, using default hyperparameters. Based on correlated coefficient some features get dropped. Further, with the remaining variables, another round of feature reduction is done by applying a Boruta algorithm. This process reduces some additional variables. Before the present techniques, when a Boruta algorithm was conducted using all the variables, it used too much time, and some of the time the process terminated, as the clustering could not be supported.

However, in the present disclosure, using correlation coefficients, some variables are dropped before sending the list of variables through the Boruta algorithm. Further, with the remaining variables, additional feature reduction is applied by using variable clustering. Again, before developing the present techniques, using a full list of variables, a variable clustering process could take more than several months of computations. Before developing the present techniques, all the feature reduction processes took more than several months. As disclosed herein, based on the way each process has been arranged, an entire feature reduction process is completed in only a few minutes.

Modeling: The next step, in the present disclosure, is modeling, which was also a time-consuming process. Using a randomized search algorithm, the best hyperparameters are selected. Before developing the present techniques, hyperparameters were selected with manual testing, which takes a substantial amount of time. In the present disclosure, there is a final variable selection step, which keeps a balance between feature importance and variable coverage. This final variable selection step is preferably introduced before a final model is generated. In this step, a user selects a percentage of the variables based on high feature importance, and a number of variables based on coverage. Before the present techniques, this process was done manually. Earlier analysts needed to print all the variables, along with their feature importance and coverage, and then manually select the top variables based on feature importance, and then the top variables based on coverage. Manual selection was very time consuming and could take up to several months. In the present disclosure, this selection process is incorporated in the modeling process, and the user only needs to select a percentage of attributes, based on high feature importance and a number of top variables based on coverage. Based on this input selection parameter, the present disclosure selects the top variables based on feature importance and coverage, and then the final model is built using this final list of attributes or best predictors.

A unique major advantage of the present disclosure is that the run time of this package is performed in minutes, as opposed to hours or even months. It takes less than an hour to develop the model and a couple of minutes to conduct the scoring. Ultimately, the present disclosure of the insurance loss ratio forecasting framework, is exactly the speed at which the insurance industry needs the output (predicted loss ratio).

Summary of Example Log File from a Model Run Using Client Data:

This example of a Log File will demonstrate how each of the processes described in the flow chart, as shown in FIG. 1 and/or FIG. 2, is doing the variable reduction.
Initially starting with 1200 variables
Pre-processing step dropped 615 variables
Number of variables after correlation check=166 variables
Number of variables after Boruta Algorithm=104 variables
Number of variables after clustering=53 variables
Final list of predictors after running the final Light GBM Model=11 variables.

### Example Log File:

Data shape after initial read: (68214, 1270)
[‘duns’, ‘product’, ‘load_year’, ‘earned_premium_sum’, ‘incurred_claims_sum’, ‘xpctd_incurred_claims_sum’, ‘casesize_max’, ‘group_id’, ‘group_name’, ‘coverage_desc’, ‘funding_type’, ‘incurred_yr’, ‘frstincmth’, ‘lastincmth’, ‘incmthent’, ‘casesize’, ‘effective_dt’, ‘earned_premium’, ‘incurred_claims’, ‘xpctd_incurred_claims’, ‘grpname1’, ‘grpname2’, ‘street_addr_1’, ‘street_addr_2’, ‘city’, ‘state’, ‘industry_code’, ‘sequencenumber’, ‘match_code’, ‘bemfab_marketability’, ‘matchgrade’, ‘confidence_code’, ‘recertification_reason_code’, ‘effective_date’, ‘year_effective_dt’, ‘month_effective_dt’, ‘load_month_actual’, ‘indicator’, ‘impt_expt_code’, ‘d_slow’, ‘d_neg’, ‘d_slng’, ‘d_sat’, ‘d_cur’, ‘d_30’, ‘d_60’, ‘d_90’, ‘d_120’, ‘d_180’, ‘d_999’, ‘d_oth’, ‘d_npm’, ‘d_pm’, ‘duns_for_csad’, ‘indicator_csad’, ‘duns_for_da_dtri’, ‘indicator_da_dtri’, ‘duns_for_da_spend’, ‘indicator_da_spend’, ‘duns_for_da_inquiries’, ‘indicator_da_inquiries’, ‘year1’, ‘1983_date’, ‘pydexvar’, ‘d_90p’, ‘d_120p’, ‘d_30p’, ‘d_60p’, ‘d_180p’, ‘fin_ind’, ‘loss_ratio’, ‘target_catg’]
Number of variables not identified via mapping file: 72

These variables will be dropped in the model building process.
‘ALL’ chosen, current data shape: (68214, 1200)
Pre-processing start--->
Total number of variables dropped in pre-processing: 621

Pre-processing drops include checks based on duns & dates columns, drops via a common drop list, singular unique and missing value.
Current data shape: (68214, 615)
Bin creation start--->
Loss ratio and bins created, time taken: 0.4464128017425537 seconds
Current data shape: (68214, 617)
Splitting data into train and test--->
Split complete, time taken: 2.3097450733184814 seconds
Starting imputations--->
Imputations complete, segment added, time taken: 17.63094186782837 seconds
Current data shape (full data): (68214, 618)
Dropping variables identified via custom drop list, and premium+loss columns--->
Current data shape (train): (47749, 616)
Current data shape (test): (20465, 616)
Ranking features with Random Forest Regressor--->
Ranking complete, time taken: 1328.506011724472 seconds
Correlation calculations start--->
Correlation calculation complete, time taken: 38.26158404350281 seconds
Number of variables (after correlation check): 166
Starting BoostARoota (Boruta) Feature Selection--->
Round: 1 iteration: 1
Round: 1 iteration: 2
Round: 1 iteration: 3
Round: 1 iteration: 4
Round: 1 iteration: 5
Round: 2 iteration: 1
Round: 2 iteration: 2
Round: 2 iteration: 3
Round: 2 iteration: 4
Round: 2 iteration: 5

BoostARoota ran successfully! Algorithm went through 2 rounds.
Number of variables (after Boruta): 104
Number of variables for clustering: 104
Variable clustering start--->
Choosing NumPy version of VarClusHi . . .
Variable clustering complete, time taken: 19.588462352752686 seconds
Number of variables selected from clustering rules: 53
Randomized Search Cross-Validation (CV) start--->
Finding best hyperparameters--->
Fitting 5 folds for each of 10 candidates, totaling 50 fits
[Parallel(n_jobs=−1)]: Using backend LokyBackend with 16 concurrent workers.
[Parallel(n_jobs=−1)]: Done 18 tasks elapsed time: 16.2 seconds
[Parallel(n_jobs=−1)]: Done 50 out of 50|elapsed time: 24.0 seconds finished
Randomized Search CV end.
Fitting model with best hyperparameters--->
Fit complete, time taken: 26.633434295654297 seconds
Randomized Search CV (2nd) start--->
Finding best hyperparameters for final predictors--->
Fitting 5 folds for each of 10 candidates, totaling 50 fits
[Parallel(n_jobs=−1)]: Using backend LokyBackend with 16 concurrent workers.
[Parallel(n_jobs=−1)]: Done 18 tasks|elapsed time: 6.7 seconds
[Parallel(n_jobs=−1)]: Done 50 out of 50|elapsed time: 10.9 seconds finished
Randomized Search CV (2nd) end.
Fitting model with best hyperparameters--->
Final fit complete, time taken: 13.543337106704712 seconds
Number of final predictors selected: 11
SHAP value calculation start--->
SHAP value calculation complete, time taken: 21.1549129486084 seconds
   Example of Hyperparameters from One Model:

HYPERPARAMETERS FROM ONE MODEL

| boosting_type = | gbdt |
|---|---|
| objective = | regression |
| colsample_bytree = | 0.8 |
| learning_rate = | 0.01 |
| max_depth = | 5 |
| min child_weight = | 11 |
| n_estimators = | 500 |
| reg_lambda = | 1.5 |
| seed = | 1337 |
| subsample = | 0.8 |
| silent = | 1 |

Example of Final Predictors from One Model:

| Variable Name | Source | Description |
|---|---|---|
| dt_61p_3m_61p_acct_av_amt | DTRI | The ratio of total amount 61 or more days past due to |
| | | the number of accounts 61 or more days past due |
| | | during the most recent month and 3 months prior. |
| dt_pd_3m_pd_acct_av_amt | DTRI | The ratio of total amount past due to the number of |
| | | accounts past due during the most recent month and |
| | | 3 months prior. |
| inq_inquirer_sic_5_60m | INQ | # of inquiries made to D&B on this business by |
| | | businesses in the transportation, communications, |
| | | and utilities industries in the last 60 months. |
| uccfilng | CSAD | Total # of UCC filings. |
| inq_sic42_inq_60m | INQ | # of inquiries made to D&B on this business by |
| | | businesses in trucking and warehousing in the last 60 |
| | | months. |
| inq_inquirer_sic_0_6m | INQ | # of inquiries made to D&B on this business by public |
| | | administration (government) entities in the last 6 |
| | | months. |
| corptype | CSAD | Corporation type. |
| dliens | CSAD | $$$ in liens (liens - dollar amount). |

### ALTERNATIVES, EQUIVALENTS AND RANGES

Risk-based missing value imputation. Traditional models impute the missing values by overall median or mean. However, this approach will reduce the variance in the data and thereby reduces the model performance. In the present disclosure of the insurance loss ratio forecasting framework, risk-based imputation is introduced, and in the OOT sample, risk-based segmentation can be achieved by applying cosine similarity. The system and method help to retain the variance in the data, and significantly improve the model performance.

The capture rate in the OOT sample in the extreme Loss Ratio buckets particularly [(Low—10%) and (90%—High)], is approximately 18% or more. In a traditional GLM model, the captures rates in the extreme Loss Ratio buckets particularly [Low—10%] and (90%—High], is only approximately 1%. However, utilizing the present disclosure of the insurance loss ratio framework, the capture rate in these buckets increases to 20% or more.

The techniques described herein are exemplary and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

What is claimed is:

1. A system for insurance loss ratio forecasting, utilizing a framework consisting of risk-based segmentation using unsupervised machine learning, comprising:
a computer processor;
a memory for storing a set of instructions for the computer processor;
a plurality of databases, accessible by said processor, including at least a database of variables, a database of features, and a database of hyperparameters,
wherein the set of instructions in the memory cause the computer processor to perform steps of:
using a combination of correlation, cluster analysis and feature importance for a feature reduction of variables in a first selection,
wherein the feature reduction of variables is reduced in a second selection using a Boruta algorithm; and
capturing features involving a combination of coverage rate and feature importance from a Light GBM model;
tuning of selected features from the second selection,
utilizing a randomized search algorithm, which utilizes different combinations of hyperparameters, and
selecting a best set of hyperparameters that provide a maximum R-square in a model development;
wherein risk-based segmentation is used in the model development, and in order to capture the risk-based segmentation in a OOT sample dataset and a production sample dataset for an insurance loss ratio forecast, and
unsupervised machine learning (ML) utilizing cosine similarity technique, is leveraged to capture the risk-based segmentation.

2. The system of claim 1, wherein the best set of hyperparameters are final predictors of the model development.

3. The system of claim 2, wherein the final predictors of the model development comprise a ratio of a total amount of 61 or more days past due to a number of accounts of 61 or more days past due during a most recent month and 3 months prior.

4. The system of claim 2, wherein the final predictors of the model development comprise a ratio of a total amount past due to a number of accounts past due during a most recent month and 3 months prior.

5. The system of claim 2, wherein the final predictors of the model development comprise a number of inquiries made on a business by businesses basis in transportation, communications, and utilities industries in the last 60 months.

6. A method for insurance loss ratio forecasting, utilizing a framework consisting of risk-based segmentation using unsupervised machine learning, comprising:
using a combination of correlation, cluster analysis and feature importance for a feature reduction of variables in a first selection,
wherein the feature reduction of variables is reduced in a second selection using a Boruta algorithm; and
capturing features involving a combination of coverage rate and feature importance from a Light GBM model;
tuning of selected features from the second selection,
utilizing a randomized search algorithm, which utilizes different combinations of hyperparameters, and
selecting a best set of hyperparameters that provide a maximum R-square in a model development;
wherein risk-based segmentation is used in the model development, and in order to capture the risk-based segmentation in a OOT sample dataset and a production sample dataset for an insurance loss ratio forecast, and
unsupervised machine learning (ML) utilizing cosine similarity technique, is leveraged to capture the risk-based segmentation.

7. The method of claim 6, wherein the best set of hyperparameters are final predictors of the model development.

8. The method of claim 7, wherein the final predictors of the model development comprise a ratio of a total amount of 61 or more days past due to a number of accounts of 61 or more days past due during a most recent month and 3 months prior.

9. The method of claim 7, wherein the final predictors of the model development comprise a ratio of a total amount past due to a number of accounts past due during a most recent month and 3 months prior.

10. The method of claim 7, wherein the final predictors of the model development comprise a number of inquiries made on a business by businesses basis in transportation, communications, and utilities industries in the last 60 months.

11. A system for insurance loss ratio forecasting, utilizing a framework consisting of risk-based segmentation using unsupervised machine learning, comprising:
a computer processor;
a memory for storing a set of instructions for the computer processor;
a plurality of databases, accessible by said processor, including at least a database of variables, a database of features, and a database of hyperparameters,
wherein the set of instructions in the memory cause the computer processor to perform steps of:
using a combination of correlation, cluster analysis, feature importance, and missing value imputation for a feature reduction of variables in a first selection,
wherein the feature reduction of variables is reduced in a second selection using a Boruta algorithm; and
capturing features involving a combination of coverage rate and feature importance from a Light GBM model;
tuning of selected features from the second selection,
utilizing a randomized search algorithm, which utilizes different combinations of hyperparameters, and
selecting a best set of hyperparameters that provide a maximum R-square in a model development;
wherein risk-based segmentation is used in the model development, and in order to capture the risk-based segmentation in a OOT sample dataset and a production sample dataset for an insurance loss ratio forecast, and
unsupervised machine learning (ML) utilizing cosine similarity technique, is leveraged to capture the risk-based segmentation.

12. The system of claim 11, wherein the missing value imputation comprises an unsupervised machine learning (ML) model derived through cosine similarity to assign risk-based segmentation for a full dataset and to impute missing values in the full dataset with median values corresponding to specific risk segments that are used in a base data repository.

13. The system of claim 12, wherein the missing value imputation comprises an unsupervised machine learning (ML) model derived through cosine similarity to at least:
(a) create a base dataset that is used for mapping;
(b) create loss ratio bins and impute missing values based on median values corresponding to those bins;
(c) randomly draw a population and save it as base data for cosine similarity; and
(d) assign risk-based segmentation for a full dataset and impute missing values in the full dataset with median values corresponding to specific risk segments that are used in a base data repository.

14. A method for insurance loss ratio forecasting, utilizing a framework consisting of risk-based segmentation using unsupervised machine learning, comprising:
using a combination of correlation, cluster analysis, feature importance, and missing value imputation for a feature reduction of variables in a first selection,
wherein the feature reduction of variables is reduced in a second selection using a Boruta algorithm; and
capturing features involving a combination of coverage rate and feature importance from a Light GBM model;
tuning of selected features from the second selection,
utilizing a randomized search algorithm, which utilizes different combinations of hyperparameters, and
selecting a best set of hyperparameters that provide a maximum R-square in a model development;
wherein risk-based segmentation is used in the model development, and in order to capture the risk-based segmentation in a OOT sample dataset and a production sample dataset for an insurance loss ratio forecast, and
unsupervised machine learning (ML) utilizing cosine similarity technique, is leveraged to capture the risk-based segmentation.

15. The method of claim 14, wherein the missing value imputation comprises an unsupervised machine learning (ML) model derived through cosine similarity to assign risk-based segmentation for a full dataset and to impute missing values in the full dataset with median values corresponding to specific risk segments that are used in a base data repository.

16. The method of claim 15, wherein the missing value imputation comprises an unsupervised machine learning (ML) model derived through cosine similarity to at least:
(a) create a base dataset that is used for mapping;
(b) create loss ratio bins and impute missing values based on median values corresponding to those bins;
(c) randomly draw a population and save it as base data for cosine similarity; and
(d) assign risk-based segmentation for a full dataset and impute missing values in the full dataset with median values corresponding to specific risk segments that are used in a base data repository.
